(19) United States
(12) Patent Application Publication
(10) Pub. No.: US 2025/0070260 A1
(43) Pub. Date: Feb. 27, 2025

(54) SLOT ELECTRODE STACK AND ELECTROCHEMICAL CELLS AND BATTERIES CONTAINING A SLOT ELECTRODE STACK

(71) Applicant: ADVANCED CELL ENGINEERING, INC., Stuart, FL (US)

(72) Inventors: John Kaufman, Palm City, FL (US); Karim Zaghib, Longueil (CA); Ayyakkannu Manivannan, Stuart, FL (US); Thomas Madden, Stuart, FL (US)

(21) Appl. No.: 18/561,713

(22) PCT Filed: Nov. 8, 2022
(86) PCT No.: PCT/US2022/049326

§ 371 Date: Nov. 16, 2023

Related U.S. Application Data
(60) Provisional application No. 63/277,083, filed on Nov. 8, 2021.
(60) Provisional application No. 63/277,084, filed on Nov. 8, 2021.
(60) Provisional application No. 63/310,979, filed on Feb. 16, 2022.
(60) Provisional application No. 63/340,353, filed on May 10, 2022.
(60) Provisional application No. 63/400,355, filed on Aug. 23, 2022.
(60) Provisional application No. 63/410,538, filed on Sep. 27, 2022.

(51) Int. Cl. H01M 10/0583; H01M 4/02; H01M 4/131; H01M 4/38; H01M 4/505; H01M 4/525; H01M 4/58; H01M 4/587; H01M 10/0525; H01M 50/411; H01M 50/466

(52) U.S. Cl. CPC H01M 10/0583; H01M 4/131; H01M 4/386; H01M 4/505; H01M 4/525; H01M 4/5825; H01M 4/587; H01M 10/0525; H01M 50/411; H01M 50/466; H01M 2004/029

(57) ABSTRACT

The disclosure provides a slot electrode stack including an electrically insulative separator folded into an accordion shape and having a plurality of first slots on one side and a plurality of second slots on an opposite side, a plurality of cathodes located in the plurality of first slots, and a plurality of anodes located in the plurality of second slots. The disclosure further provides a slot electrode cell including such a slot electrode stack and a slot electrode battery including at least one such slot electrode cell. The disclosure further provides a method of forming a slot electrode stack.

### PRIORITY CLAIM

The present application claims priority to U.S. Provisional Patent Application No. 63/277,083, filed Nov. 8, 2021, titled “BIPOLAR LITHIUM ION CATHODES AND CELLS AND BATTERIES CONTAINING LITHIUM ION CATHODES”, U.S. Provisional Patent Application No. 63/400,355, filed Aug. 23, 2022, titled “BIPOLAR LITHIUM ION CATHODES AND CELLS AND BATTERIES CONTAINING LITHIUM ION CATHODES”, U.S. Provisional Patent Application No. 63/277,084, filed Nov. 8, 2021, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/410,538, filed Sep. 27, 2022, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/310,979, filed Feb. 16, 2022, titled “HIGH CAPACITY LITHIUM ION ANODES AND CELLS AND BATTERIES CONTAINING LITHIUM ION ANODES”, and U.S. Provisional Patent Application No. 63/340,353, filed May 10, 2022, titled “SLOT ELECTRODE STACK AND ELECTROCHEMICAL CELLS AND BATTERIES CONTAINING A SLOT ELECTRODE STACK”, each of which is incorporated by reference herein in its entirety.

### TECHNICAL FIELD

The present disclosure relates to electrode stacks having a slotted structure created by an accordion-shaped separator, which may facilitate stacking and alignment, as well as electrochemical cells and batteries containing such electrode stacks.

### BACKGROUND

Lithium batteries are widely used in consumer electronics due to their relatively high energy density. Rechargeable batteries are also referred to as secondary batteries, and lithium ion batteries are typically secondary batteries. Lithium ion secondary batteries generally have a negative electrode (anode) material that intercalates lithium and a positive electrode (cathode) material, such a lithium cobalt oxide, LiMn₂O₄, having a spinel structure, and LiFePO4, having an olivine structure, that intercalates and de-intercalates lithium while generally maintaining its crystal structure.

In conventional lithium ion batteries, layers of cathodes and anodes may be stacked on one another. However, these layers require precise manufacturing techniques for proper placement and may shift during battery use, negatively affecting performance. In addition, conventional manufacturing techniques for electrode layering require the edges of the electrode stack to be trimmed, which can cause damage to the nearby electrode areas and also results in edge effects, both of which also negatively affect battery performance.

### SUMMARY

The present disclosure provides a slot electrode stack comprising: an electrically insulative separator folded into an accordion shape and having a plurality of first slots on one side and a plurality of second slots on an opposite side; a plurality of cathodes located in the plurality of first slots; and a plurality of anodes located in the plurality of second slots.

In more specific embodiments, which may be combined with one another and with any other aspects of the present disclosure:
the slot electrode stack further comprises a plurality of stopping points, each located at an end of a first slot or a second slot;
the plurality of cathodes and plurality of anodes do not reach the plurality of stopping points;
the plurality of cathodes each comprise a cathode active material in a cathode active material layer on a cathode current collector;
each cathode comprises a cathode active material layer on both sides of the cathode current collector;
the cathode active material comprises a lithium metal oxide, a lithium metal phosphate, or any combinations thereof;
the lithium metal oxide or phosphate comprises lithium cobalt oxide, lithium nickel aluminum oxide, lithium nickel manganese cobalt oxide (“NMC”), lithium nickel cobalt aluminum oxide (“NCA”), lithium nickel manganese cobalt aluminum oxide (“NMCA”) lithium iron phosphate (“LFP”), lithium manganese iron phosphate (“LMFP”), lithium manganese nickel iron phosphate (“LMCFP”), lithium iron cobalt phosphate (“LFCP”), lithium iron manganese cobalt phosphate (LFMCP″), or any combinations thereof;
the plurality of anodes each comprise an anode active material in an anode active material layer on an anode current collector;
each anode comprises an anode active material layer on both sides of the anode current collector;
the anode active material comprises a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof;
the anode further comprises a lithium ion reservoir;
the anode further comprises a cathode active material;
the separator comprises polyethylene, polypropylene, a ceramic-polymer composite, polyvinylidene fluoride (PVDF), PVDF-poly(ethylene oxide) (PEO), or any combinations thereof; or
the plurality of cathodes and plurality of anodes each have at least two tabs that allow current to flow to and from the cathodes and anodes.

The present disclosure further provides a slot electrode cell comprising: a slot electrode stack as described above or otherwise herein; an electrolyte; and a casing.

In more specific embodiments, which may be combined with one another and with any other aspects of the present disclosure:
the slot electrode cell is substantially flat and has a length, width, and height;
the slot electrode cell is a prismatic cell or a pouch cell; or
the slot electrode cell has a length and a width, at least one of which is at least 15 cm.

The present disclosure further provides a slot electrode battery comprising: at least one slot electrode cell according to the above or any other part of the present disclosure; a positive connector; a negative connector; and a housing.

In more specific embodiments, which may be combined with one another and with any other aspects of the present disclosure:
the slot electrode battery further comprises safety equipment, control equipment, or any combinations thereof.
the battery is configured for use in a vehicle, ship, or grid-storage.

The present disclosure further provides a method of forming a slot electrode stack comprising: inserting a plurality of cathodes into a plurality of first slots on one side of an electrically insulative separator folded into an accordion shape; and inserting a plurality of anodes into a plurality of second slots on an opposite side of the separator.

In more specific embodiments, which may be combined with one another and with any other aspects of the present disclosure:
the slot electrode stack is according to the above or any other part of the present disclosure.

### BRIEF DESCRIPTION OF THE DRAWINGS

The disclosure may be better understood through reference to the following figures, which are not to scale, which depict embodiments of the present disclosure, and in which:

FIG. 1 is a schematic, elevation view of the accordion-shaped separator and the electrodes prior to complete assembly into a slot electrode stack;

FIG. 2 is a schematic, elevation view of the slot electrode stack of FIG. 1 after assembly;

FIG. 3 is a schematic, top, cross-sectional-view diagram of a cell containing a slot electrode stack, with a cross-sectional view of the internal electrode stack structure shown as an inset;

FIG. 4 is an isometric diagram of a cell containing a slot electrode stack with gaps.

FIG. 5 is a schematic diagram of an electric vehicle battery including a battery module or pack, including slot electrode cells.

### DETAILED DESCRIPTION

The present disclosure relates to electrode stacks having a slotted structure created by an accordion-shaped separator, which may be referred to as “slot electrodes” or “slot electrode stacks,” as well as electrochemical cells and batteries containing such electrodes, which may be referred to as “slot electrode cells” or “electrode batteries,” respectively. Slot electrodes may be used in any cell or battery containing stacked electrodes, including both primary and secondary cells and batteries. In specific embodiments, the cell or battery may be a secondary (rechargeable) cell or battery, such as a lithium ion or sodium ion battery. In some embodiments, the cell or battery may be in a prismatic or pouch cell format or other format having a substantially flat electrode stack. In some embodiments, the slot electrode stack may be resistant to displacement and resultant negative performance effects during cell or battery use. In some embodiments, the slot electrode cell or slot electrode battery may be a large format cell or battery, such as a rectangular or square cell or battery having a width or length of at least 15 cm.

The present disclosure also relates to methods of assembling an electrode stack, cell, or battery using an accordion-shaped separator that forms a slotted structure. In some embodiments, the method may facilitate precise placement of the electrodes and separator in an electrode stack.

As used herein following terms are ascribed the following meanings:

Chemical abbreviations are employed as is typical in the art. For example, a lithium ion may be designated as Lit and an electron may be designated as e⁻. Weight % may be abbreviated as “wt %.”

A “cathode” (which may also be referred to as a “positive electrode”) is the electrode to which, during discharge of a lithium ion electrochemical cell, electrons flow and combine with lithium ion (typically in the context of a metal oxide insertion or de-insertion of the lithium ion). During charge of the electrochemical cell, electrons flow from the cathode and lithium ions are also released from the cathode.

A “cathode active material” is a chemical that undergoes electrochemical reaction in the cathode to exchange lithium ions and electrons with other components of the electrochemical cell.

A “bipolar cathode” is a cathode including two different layers that differ in their cathode active material compositions and, thus, also in their energy density and power density. In the simplest version of a bipolar cathode, a first layer contains a first cathode active material and the second layer contains a second cathode active material, which differs in chemical composition and at least one electrochemical property from the first cathode active material. “Bipolar cathode” does not denote a conventional bipolar battery stack configuration.

An “anode” (which may also be referred to as a “negative electrode”) is the electrode from which, during discharge of a lithium ion electrochemical cell, electrons flow and from which lithium ions are released. During charge of the electrochemical cell, electrons flow to the anode, where they combine with lithium ion, often to form lithium metal (Li).

An “anode active material” is a chemical that undergoes electrochemical reaction in the anode to exchange lithium ions and electrons with other components of the electrochemical cell, or upon which lithium metal may be plated or removed as lithium ions and electrons are separated and recombined by the electrochemical reaction.

A “current collector” is a component of the cathode or anode that exchanges electrons directly or indirectly with the active material to allow the electrochemical reaction to proceed.

An “electrolyte” is a substance that can exchange lithium ions with the cathode and anode. Although many examples in the present specification relate to liquid electrolytes, suitable non-liquid electrolytes, such as gel or solid electrolytes, may also be used in electrochemical cells encompassed by the present disclosure.

A “cell” or “electrochemical cell” is a basic physical unit in which a complete electrochemical reaction may occur if the cell is electrically connected to an external energy sink or energy source. An electrochemical cell includes a cathode, and anode, and an electrolyte. Unless the electrolyte forms an electrically non-conductive barrier between the anode and cathode, the electrochemical cell also contains a separator that forms an electrically non-conductive barrier between the anode and cathode. An electrochemical cell also includes a casing that maintains the electrochemical cell as a physical unit, such as by containing a liquid electrolyte, excluding air or water from the cell, or protecting the cell components from physical damage.

A “battery” is a more complex physical unit that includes at least one electrochemical cell combined with at least one other component not a part of the electrochemical cell, such as a housing or a second or more electrochemical cells. A battery may also include other components, such as vents, air circulation systems, fire suppression systems, electrical conductors, such as wiring or bars, identification components, and even a processor and associated memory, which may for example, assess battery status and control battery functions.

“Uncycled” refers to a cell or battery that has never been charged and discharged or to an anode or cathode or an anode active material or cathode active material that has never been charged and discharged in a cell or battery.

“Hard carbon” is a solid form of carbon that cannot be converted to graphite by heat-treatment at temperatures up to 3000° C. and may also be referred to as “non-graphitizing carbon” as a result. Hard carbon may be formed by heating a suitable carbon-based precursor to 1000° C. in the absence of oxygen.

Unless otherwise specified, the term “including” is used in the expansive sense and means “not limited to.” Likewise, “or” is used expansively and means both one of the listed options and combination of more than one of the listed options (i.e. and/or). “A” “an,” and “the” include more than one. “About,” as used herein, means within a variation of 1%.

All lists with items disclosed herein should be interpreted as including any combinations thereof unless otherwise specified.

All bounded and unbounded ranges recited herein should be interpreted as including both all values between the endpoint values (or above or below the endpoint value, as the case may be, for unbounded ranges) and the endpoint values. The terms “in a range from” and “between” both include endpoint values.

### Slot Electrodes

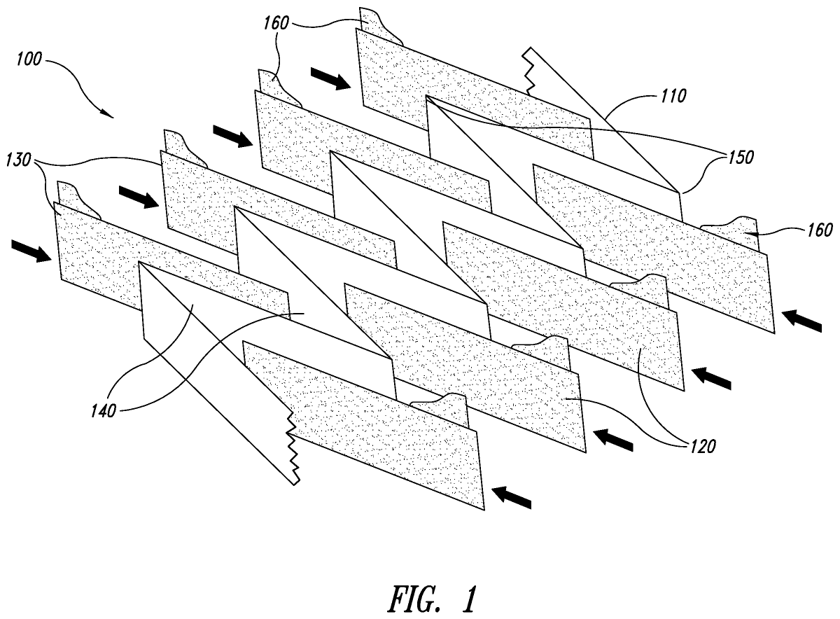

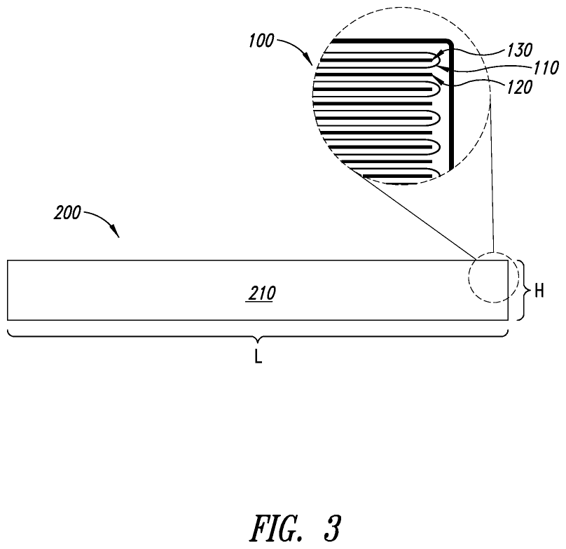

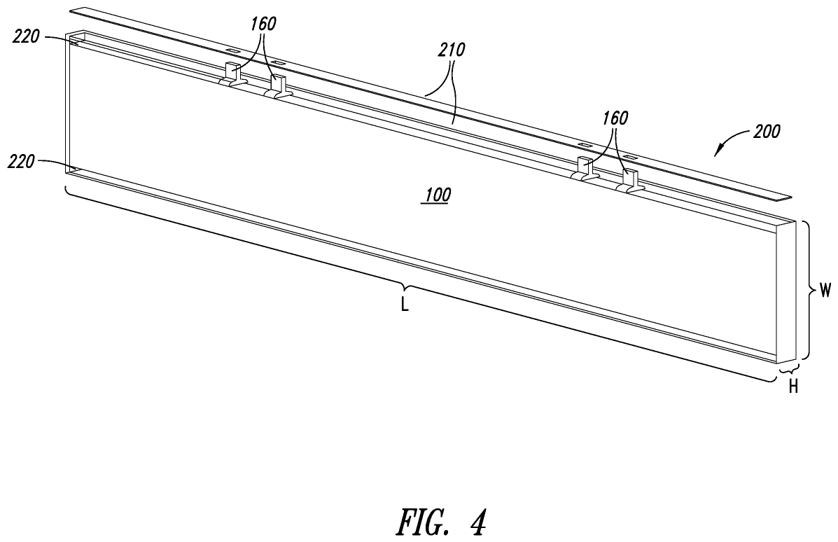

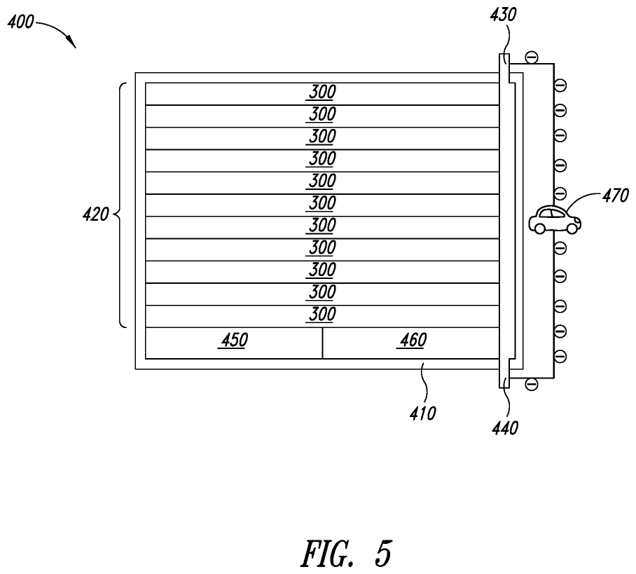

Referring now to FIGS. 1-4, the present disclosure, according to some embodiments provides an electrochemical cell, which may be in a battery, for example battery 200 (FIG. 3) or battery 400 (FIG. 5), that include a slot electrode stack, such as electrode stack 100. The slot electrode stack 100 (FIG. 4) includes a cathode 120, an anode 130, and a separator 110 (FIG. 1).

Cathode 120 includes at least one cathode active material-containing layer that contains at least one cathode active material. Cathode 120 further includes a cathode current collector on which the cathode active material-containing layer is located.

Anode 130 includes at least one anode active material-containing layer that contains at least one anode active material. Anode 130 further includes an anode current collector on which the anode active material-containing layer is located.

Separator 110 electrically insulates cathode 120 from anode 130 within the electrode stack 100 when placed in an electrochemical cell or battery.

The cell or battery also contains an electrolyte, which may be a solid, liquid, or gel electrolyte. If the electrolyte is a solid electrolyte, it may take the place of separator 110, or it may be located adjacent to separator 110 on one or both sides of separator 110. The electrolyte contains the working ion, which is the ion that is exchanged by the electrolyte with the cathode active material and the anode active material.

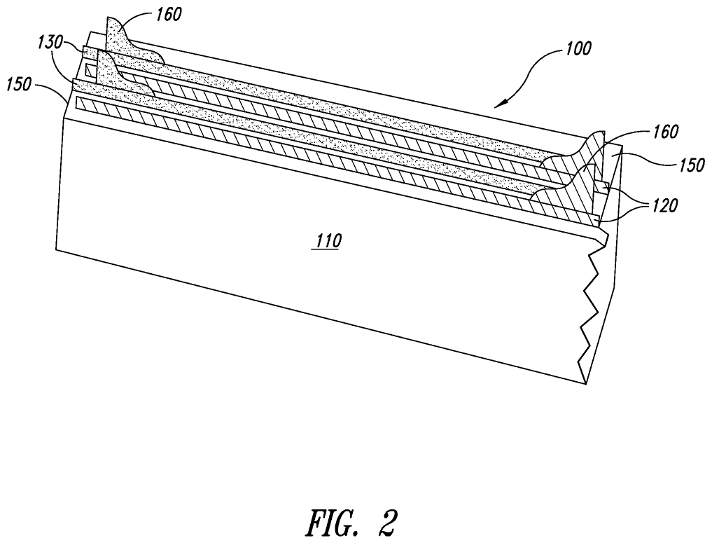

Separator 110 is folded into an accordion shape, as depicted in FIG. 1 and FIG. 2, which creates slots 140 on alternating sides of separator 110 into which cathodes 120 and anodes 130 fit so that there is separator on both sides of each cathode 120 and each anode 130.

FIG. 1 illustrates slot electrode stack 100 during its assembly, when flat cathodes 120 and flat anodes 130 are being inserted into slots 140 of the accordion-shaped, folded separator 110 in the directions indicated by the arrows. As depicted in FIG. 1, cathodes 120 are inserted laterally from a first side of separator 110 into slots 140 opening on the first side, while anodes 130 are inserted laterally from a second side of separator 110 into slots 140 opening on the second side. After insertion, a completed slot electrode stack 100 as shown in FIG. 2 is formed. In the completed slot electrode stack 100, cathodes 120 alternate with anodes 130, with separator 110 between each cathode 120 and anode 130. All cathodes 120 are located in slots of separator 110 that open towards the first side of separator 110 (not labelled), while all anodes 130 are located in slots of separator 110 that open towards the second side of separator 110 (not labelled). This alternating arrangement of cathodes and anodes can also be seen in the inset of FIG. 3, in which slots (not labelled) that open towards the first side are visible.

The accordion shape of separator 110 ensures that, so long as cathodes 120 and anodes 130 are inserted laterally from opposite sides of separator 110, a cathode 120 cannot be placed in slot electrode stack 100 touching an anode 130. This avoids accidental manufacture of an electrode stack with a short circuit between an anode and cathode that are in electrical contact with one another within the electrode stack, a problem that can render the electrode stack inoperable or unsafe when placed in a cell or battery.

In addition, if a slot 140 in separator 110 is missed during manufacture, and does not receive an anode 130 or a cathode 120, the electrode stack simply has two anodes or two cathodes adjacent one another, but separated by two layers of separator 110. Although such a configuration is not optimal and may affect energy density or power density of the cell or battery containing the electrode stack, it does not render the electrode stack inoperable or unsafe.

In addition to helping avoid creating inoperable or unsafe electrode stacks, the accordion-shaped separator 110 also makes manufacture of electrode stack 100 easier than manufacture of a similar electrode stack with alternating flat sheets of cathode, anode, and separator because the slots 140 in separator 110 created by the accordion shape guide the cathodes 120 and anodes 130 into place and provide a physical stopping point in the separator 110 fold at the end of each slot 140.

In addition, electrode stack 100 is resistant to displacement of cathodes 120 and anodes 130 during use of a cell or battery that contains electrode stack 100 as compared to an electrode stack that lack an accordion-shaped separator because the physical stopping point 150 in the separator 110 fold at the end of each slot 140 prevents electrode displacement in the direction of that stopping point 150. This displacement-resistance helps avoid the negative effects of electrode displacement, such as decreased capacity, energy density, or power density. In addition, the folded accordion-shaped structure of separator 110 makes it physically impossible, absent disruption of the separator, for the anodes 130 to contact the cathodes 120 on at least two sides of the electrode stack 100 (the sides from which the anodes 130 and cathodes 120 are inserted), even if displacement occurs. This greatly reduces the chances of an anode 130 becoming in electrical contact with a cathode 120 within the electrode stack 100 during use, even if some displacement occurs. To additionally avoid any displacement, the completed slot electrode stack may be physically contained, for example in a membrane, such as a plastic wrap.

In some embodiments, the cathodes 120 and anodes 130 may not reach the physical stopping points 150 when the electrode stack 100 is first assembled. The extra space between the end of the electrode and the stopping point 150 in the separator 110 may provide extra separator 110 past the ends of the electrodes, which may help control dendrite formation. However, the electrode stack 100 will still benefit from constraints on electrode movement because, even if the cathodes 120 and the anodes 130 shift at some point after assembly, they may move closer to the stopping points 150 and lose the benefit of extra separator 110 extending past their ends, but they will not be able to shift past the stopping points 150.

Cathodes 120 and anodes 130 may further include tabs 160 that allow current to flow to and from each electrode. Although each cathode 120 and each anode 130 may have only a single tab 160, as illustrated in FIG. 1 and FIG. 2, it is also possible, as illustrated in FIG. 4 for each cathode 120 and each anode 130 to have two or more, three or more, four or more, five or more, between one and twenty, between one and ten, between two and twenty, between two and ten, between three and twenty, between three and ten, between four and twenty, between four and ten, between five and twenty, or between five and ten tabs 160 on each cathode 120 and each anode 130. Although FIG. 1 and FIG. 2 are illustrated with only one tab 160 on each electrode for simplicity, the configurations shown in both of these figures may have a plurality of tabs 160 as described above.

A plurality of tabs 160 allows current to flow to and from each electrode at multiple locations, which may improve charge or discharge efficiency because current does not need to travel as far within the electrode to reach a tab. A plurality of tabs 160 may be particularly useful in large format cells, such as that illustrated in FIG. 4 and described in further detail below.

Tabs 160 may be formed from the same material as or contiguous with the respective cathode and anode current collectors.

In some embodiments, each cathode 120 and each anode 130 may have a tab 160 at least every 2 cm, 5 cm, 10 cm, or 20 cm along its longest dimension.

### Slot Electrode Cells and Batteries

As shown in FIG. 3 and FIG. 4, a slot electrode cell 200 may be formed by placing a substantially flat slot electrode stack 100 within a casing 210. The cell 200 has a height, H, that may be based substantially on the thickness of the slot electrode stack 100 as measured across the alternating layers of cathodes 120, anodes 130, and separator 110. The cell 200 also has a length, L, and a width. In some embodiments, referred to as “large format” cells or batteries, at least one of the length or width may be at least 15 cm, at least 30 cm, at least 50 cm, up to 1 m, up to 75 cm, up to 50 cm, up to 30 cm, or in a range between 15 cm and 30 cm, 15 cm and 50 cm, 15 cm and 75 cm, 15 cm and 1 m, 30 cm and 50 cm, 30 cm and 75 cm, 30 cm and 1 m, 50 cm and 75 cm, 50 cm and 1 m, or 75 cm and 1 m.

The cell 200 illustrated in FIG. 3 is a prismatic cell format, but other substantially flat battery formats, such as those with electrode or contact placements above or below the L×W plane (as opposed to in the L×W plane, as in a prismatic cell) and pouch cells are also possible.

Prismatic cell battery 300 further includes a casing 310, which is illustrated as a metal pouch. Prismatic cell battery 300 may have a length, L which may be between about 10 cm and about 1 m, between about 10 cm and about 500 cm, between about 10 cm and between about 100 cm, between about 25 cm and about 1 m, between about 25 cm and about 500 cm, between about 25 cm and about 100 cm, between about 50 cm and about 1 m, between about 50 cm and about 500 cm, between about 50 cm and about 100 cm, between about 100 cm and 1 m, or between about 100 cm and about 500 cm, a width, W, which may be between about 2 cm and about 20 cm, about 2 cm and about 10 cm, about 2 cm and about 5 cm, about 5 cm and about 20 cm, or about 5 cm and about 10 cm, and a height, H, between about 2 cm and about 50 cm, about 2 cm and about 20 cm, about 2 cm and about 10 cm, about 5 cm and about 50 cm, about 5 cm and about 20 cm, about 5 cm and about 10 cm, about 10 cm and about 50 cm, or about 10 cm and about 20 cm, in any combinations of these ranges of lengths, width, and heights.

Casing 210 may be any material able to contain any liquid, solid or gel electrolyte, and cause electrode stack 100 to maintain its integrity during use of cell 200. For example, casing 210 may be a durable plastic resistant to degradation by the electrolyte, or a metal, such as a metal, metal exterior case or pouch. If casing 210 is electrically conductive, then it may be lined with an electrical insulator that is also resistant to degradation by the electrolyte. In some embodiments, casing 210 may be a polymeric film, a metallic foil, a metal pouch, or any combination thereof. In specific embodiments, casing 210 may include polytetrafluoroethylene (PTFE), plastic, particularly translucent plastic, aluminum, an aluminum alloy, a nickel alloy, a magnesium alloy, particularly a light-weight magnesium alloy, a carbon fiber resin, or any combinations thereof. In some embodiments, casing 210 may include a vent.

A slot electrode cell, such as cell 200, may be discharged to power an external load connected to the electrode stack 100 via contacts (not shown). A slot electrode cell, such as cell 200, may be charged from an energy source, such as an AC wall outlet/power station (converted to DC power), that may also be connected to electrode stack 100 via contacts (not shown).

The voltage of any electrochemical cell or battery according to the present disclosure is the difference between the half-cell potentials at the cathode and the anode, and the cathode active materials and anode active materials may be chosen accordingly to achieve a particular voltage. The electrolyte may be chosen to avoid or decrease the amount of electrolyte degradation at the cell voltage.

As illustrated in FIG. 4, cell 200 may also contain at least one gap 220 between slot electrode stack 100 and the walls of casing 210. In the embodiment illustrated in FIG. 4, there are two gaps 220, one on either side of slot electrode stack 100 widthwise in cell 200. This placement of gaps 220 may particularly facilitate manufacturing. A gap 220 may be maintained by physical retainers within casing 210, such as tabs or pins, or by the shape of casing 210, which may be narrower in some locations to prevent movement of electrode stack 100 into a gap 220. Prior to introduction of a liquid or gel electrolyte, or if only a solid electrolyte is used, gaps 220 may be empty except for air. A liquid or gel electrolyte may fill some or all gaps 220 after introduction, or at least one gap 220, or a part of a gap 220 may remain empty except for air, depending on the type of cell and chemical species created by cell cycling. Gaps 220 may serve to contain chemical species, particularly gaseous species, created by cell cycling that are useful to retain within cell 200 rather than vent from the cell. Such species may, for example, beneficially react with other components of cell 200 during further cycling.

The slot electrode cell of FIG. 3 and FIG. 4 may be a rechargeable cell, in particular a lithium ion cell. Rechargeable cells and batteries have a range of uses, such as mobile communication devices, such as phones, mobile entertainment devices, portable computers, combinations of these devices that are finding wide use, as well as transportation devices, such as automobiles, trucks, buses and forklifts. Cells and batteries as described herein may, therefore, be used in a variety of commercial forms.

FIG. 5 illustrates a battery module or pack 400, such as an electric vehicle battery, which includes a stack 420 of slot electrode cells or batteries 300, which may be the same as cells 200 illustrated in FIG. 3 or FIG. 4, or another substantially flat battery format. Stack 420 is enclosed in a housing 410. Anodes 130 and cathodes 120 in each of cells or batteries 300 are electrically connected to negative connector 430 and positive connector 440, respectively, typically via the anode current collectors and cathode current collectors, respectively. Electrons (−) may flow between negative connector 430 and positive connector 440 to power vehicle 470, or (not shown), when connected to an energy source, such as and AC outlet (converted to DC power), to charge battery 400.

The battery 400 may also include safety equipment 450, control equipment 460, or both. Safety equipment 450 and control equipment 460 may located inside housing 410, or all or part of safety equipment 450 or control equipment 460 may be located outside housing 410. In some embodiments safety equipment 450 may include equipment that minimizes damage should one of cells or batteries 300 fail or potentially or actually cause damage. For example, safety equipment 450 may include a fan or a fire-suppression material and delivery system. In some embodiments control equipment 460 may include a processor and an associated memory, in which the processor is able to execute a program stored in the associated memory to control one or more functions of the battery 400. The processor may also receive information regarding battery 400, vehicle 470, or cells or batteries 300 and use such information to control one or more functions of battery 400.

Cell or battery 300 may be a large format battery, which may reduce the ratio of the weight of any safety equipment 450, control equipment 460, outside housing 410, and any internal connectors or conductors to the battery weight as compared to the same type of battery in a smaller format. This effectively increases the power density or energy density of the slot electrode battery 400 overall as compared to the same type of battery using smaller internal batteries.

A battery similar to that of FIG. 5 may also be used in a grid storage device, to power a ship, or in other applications where a large format battery are useful.

Batteries of the present disclosure may also be suitable for use with small electronics.

### Separators

Separator 110 may be any material that may be folded into an accordion shape without sustaining damage that prevents it from acting as a separator in a cell or battery, that holds its accordion shape for an amount of time sufficient to allow assembly of electrode stack 100, and that allows the working ion to pass through it. In some embodiments, the working ion is lithium ion (LI⁺), sodium ion (Na⁺), potassium ion (K⁺), calcium ion (Ca²⁺), or magnesium ion (Mg²⁺).

In specific embodiments, the separator may include polyethylene, polypropylene, a ceramic-polymer composite, polyvinylidene fluoride (PVDF), poly (ethylene oxide) (PEO), or any combinations thereof. In more specific embodiments, the separator is a polyethylene-polypropylene-polyethylene tri-layer membrane that can be impregnated or coated with a ceramic polymer composite.

In some embodiments, the separator 110 further includes an electrically insulative material, such as glass. In a specific embodiment, the separator 110 may include glass fibers, particularly glass fibers formed into a porous mat.

In some embodiments, the separator 110 is coated on one or both sides with a ceramic material. In more specific embodiments, the ceramic material includes oxide ceramic, sulfide, Al₂O₃, Al₂O₃—SiO₂, or any combinations thereof.

In some embodiments, the separator 110 may extend beyond at least one dimension, and possibly two dimensions of the adjacent electrodes to help control dendrite formation at the perimeters of the electrodes.

### Electrolytes

The electrolyte 100 may be a liquid, gel, or solid electrolyte.

If the electrolyte is a solid electrolyte used in place of or in addition to separator 110, the electrolyte may include a dried or crosslinked form of a polymer matrix.

The electrolyte 100 may include any electrolyte that does not substantially degrade at the cycling voltages of electrochemical cell 10.

Electrolyte 100 may include an ionic liquid, an organic liquid, or a combination thereof. If the ionic liquid or organic liquid does not supply lithium ion, then electrolyte 100 may include a lithium salt.

Electrolyte 100 may be any organic material, such as an organic liquid. If the organic liquid does not supply lithium ion, then electrolyte 100 also includes a lithium salt. In more specific embodiments, electrolyte 100 may also include an additive, such as an additive that reduces or prevents gas creating in cell 10, and additive the reduces or prevents manganese dissolution, or an additive the forms a passivation layer, particularly on the anode, or any combinations of such additives.

In some embodiments, the organic liquid may include:
an ether, such as ethylene glycol dimethyl ether (1,2-dimethoxyethane), ethylene glycol diethyl ether, tetrahydrofuran, 2-methyltetrahydrofuran, 2,6-dimethyltetrahydrofuran, tetrahydropyran, a crown ether, triethylene glycol dimethyl ether, tetraethylene glycol dimethyl ether, 1,4-dioxane, or 1,3-dioxolane;
a carbonic acid ester, such as dimethyl carbonate, methyl ethyl carbonate, diethyl carbonate, diphenyl carbonate, or methyl phenyl carbonate;
a fluorinated ethylene carbonate;
a cyclic carbonate ester, such as ethylene carbonate, propylene carbonate, ethylene 2,3-dimethyl carbonate, butylene carbonate, vinylene carbonate, or ethylene 2-vinyl carbonate;
an aliphatic carboxylic acid ester, such as methyl formate, methyl acetate, methyl propionate, ethyl acetate, propyl acetate, butyl acetate, or amyl acetate;
an aromatic carboxylic acid ester, such as methyl benzoate or ethyl benzoate;
a carboxylic acid ester, such as y-butyrolactone, y-valerolactone, or 5-valerolactone;
a phosphoric acid ester, such as trimethyl phosphate, ethyl dimethyl phosphate, diethyl methyl phosphate, or triethyl phosphate;
a nitrile, such as acetonitrile, propionitrile, methoxypropionitrile, glutaronitrile, adiponitrile, 2-methylglutaronitrile, valeronitrile, butyronitrile, or isobutyronitrile;
an amide, such as N-methylformamide, N-ethylformamide, N, N-dimethylformamide, N, N-dimethylacetamide, N-methylpyrrolidinone, N-methylpyrrolidone, or N-vinylpyrrolidone;
a sulfur-based compound, such as dimethyl sultone, methyl ethyl sultone, diethyl sultone, sulfolane, 3-methylsulfolane, or 2,4-dimethylsulfolane;
an alcohol, such as ethylene glycol, propylene glycol, ethylene glycol monomethyl ether, or ethylene glycol monoethyl ether (which, in some embodiments, may be used in a gel polymer electrolyte);
a sulfoxide, such as dimethyl sulfoxide, methyl ethyl sulfoxide, or diethyl sulfoxide;
an aromatic nitrile, such as benzonitrile or tolunitrile;
a nitromethane;
1,3-dimethyl-2-imidazolidinone;
1,3-dimethyl-3,4,5,6-tetrahydro-2(1,H)-pyrimidinone;
3-methyl-2-oxazolidinone; or any combinations thereof.

In some more specific embodiments, the organic liquid includes a carbonic acid ester, an aliphatic carboxylic acid ester, a carboxylic acid ester, an ether, or any combination thereof.

In some embodiments, the additive that reduces or prevents gas creation may include vinylene carbonate (VC), Poly (ethyl methacrylate) (PEMA), polyethyl phenylethylmalonamide (PEMAO), Li₂Co₃, and any combinations thereof.

In some embodiments, the additive that forms a passivation layer may include VC, as fluoroethylene carbonate (FEC), polyethylene oxide (PEO), and any combinations thereof.

In some embodiments, the additive reduces or prevents Mn dissolution may include VC, FEC, or any combinations thereof.

In some embodiments, the electrolyte 100 may include another additive, such as an anhydride, prop-1-ene-1,3-sultone (PES), or a combination thereof.

Electrolyte 100 may include any combinations of any or all additives.

In more specific embodiments, the total weight of additives may be about 5 wt % or less of the total electrolyte weight. In still more specific embodiments, the total weight of additive may be between about 1 wt % and about 5 wt %.

In some embodiments, the lithium salt includes LiPF₆, LiFSi, LiTFSi, KFSI, KTFSI, LiBF₄, CH₃COOLi, CH₃SO₃Li, CF₃SO₃Li, CF₃COOLi, Li₂B₁₂F₁₂, LiBC₄Oₐ;
salts with the general formula R₁—SO₂—NLi—SO₂—R₂, where R₁ and R₂ independently are F, CF₃, CHF₂, CH₂F, CHF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃;
salts with the general formula

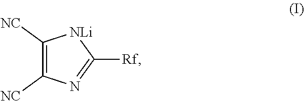

wherein Rf is F, CF_{3,} CHF₂, CHF₂, CH₂F, C₂HF₄, C₂H₂F₃, C₂H₃F₂, C₂F₅, C₃F₇, C₃H₂F₅, C₃H₄F₃, C₄F₃, C₄H₂F₇, C₄H₄F₅, C₅F₁₁, C₃F₅OCF₃, C₂F₄OCF₃, C₂H₂F₂OCF₃ or CF₂OCF_{3;} or any combinations thereof.

In more specific embodiments, the electrolyte 100 may include between about 0.5 M and about 2 M lithium salt.

In other embodiments, the electrolyte is a chemical composition or mixture of chemical compositions that do not contain lithium hexafluorophosphate as an electrolyte lithium salt. The presence of lithium hexafluorophosphate in the electrolyte composition of lithium batteries has been shown to promote the production of hydrofluoric acid and hydrogen fluoride gas, both of which can lead to increased degradation of the cell or battery. An advantage of the electrolyte compositions disclosed herein is that they avoid or lower the production hydrofluoric acid and hydrogen fluoride gas in the cell or battery, as compared to otherwise similar electrolytes containing lithium hexafluorophosphate. This increases battery safety and may increase cycle life.

The electrolyte 100 may also include an ionic liquid, alone or in combination with an organic liquid. If the ionic liquid or organic liquid does not supply the working ion, such as lithium ion, then the electrolyte also includes a working ion salt, such as a lithium salt.

In some embodiments, the ionic liquid may be any ionic liquid that is a liquid at 20° C. In more specific embodiments, the ionic liquid may include bis(fluorosulfonyl)imide (FSI), bis(trifluoromethane)sulfonamide (TFSI), imidazolium, a phosphonium phosphate, a phosphonium thiophosphate, or any combinations thereof.

In some embodiments, the electrolyte may include an additive, such as fluoroethylene carbonate (FEC), vinylene carbonate (VC), anhydrides, prop-1-ene-1,3-sultone (PES), or any combinations thereof. In more specific embodiments, the total weight of additives may be about 5 wt % or less of the total electrolyte weight. In still more specific embodiments, the total weight of additive may be between about 1 wt % and about 5 wt %.

In some embodiments, the additive that reduces or prevents gas creation may include vinylene carbonate (VC), poly(ethyl methacrylate) (PEMA), polyethyl phenylethylmalonamide (PEMAO), Li₂Co₃, and any combinations thereof.

In some embodiments, the additive that forms a passivation layer may include VC, as fluoroethylene carbonate (FEC), Poly(3,4-ethylenedioxythiophene) (PEDOT), poly(styrenesulfonate) (PSS), polyvinyl acrylate (PVA), polyethylene glycol (PEG), polyethylene oxide (PEO), poly(methyl methacrylate) (PMMA) and any combinations thereof.

In some embodiments, the additive reduces or prevents Mn dissolution may include VC, FEC, or any combinations thereof.

In some embodiments, the electrolyte 100 may include another additive, such as an anhydride, prop-1-ene-1,3-sultone (PES), or a combination thereof.

In some embodiments, including those in which the electrolyte 100 includes an ionic liquid, an organic liquid, or a combination thereof, the electrolyte 100 may further include a flame retardant. the flame retardant includes a perfluorocarbon, an alkane, an ether, a ketone, an amine substituted with one or more alkyl groups, or any combinations thereof. In more specific embodiments, the flame retardant may be at least 60% fluorinated (i.e. 60% of the individual flame retardant molecules are fluoridated).

In some embodiments, the flame retardant includes a ketone having the general formula R′(C═O)R″, wherein R′ is a perfluoroalkyl group and R″ is a perfluoroalkyl group or an alkyl group. More specifically, the ketone is a perfluoroketone, such as dodecafluoro-2-methylpentan-3-one.

In other embodiments, the flame retardant includes an ether having the general formula R′OR″, wherein R′ is a perfluoroalkyl group and R″ is a perfluoroalkyl group or an alkyl group. In more specific embodiments, the ether is a segregated hydrofluoroether, such as methoxy-heptafluoropropane, methoxy-nonafluorobutane, ethoxy-nonafluorobutane, perfluorohexylmethylether, or 2-trifluoromethyl-3-ethoxydodecofluorohexane.

In some embodiments, the flame retardant does not contain ethers or, more specifically, fully or partially halogenated ethers.

In some embodiments, the flame retardant includes an amine substituted with one or more perfluoroalkyl groups, such as perfluorotripentylamine, perfluorotributylamine, perfluorotripropylamine, or perfluoro-n-dibutylmethylamine.

In some embodiments, flame retardant can include a perfluoroalkane such as perfluoropentane, perfluorohexane, perfluoroheptane, perfluoroctane, or perfluoro-1,3-dimethylcyclohexane.

In some embodiments, the flame retardant includes a phosphazene, such as a cyclic phosphazene, more particularly cyclotriphosphazene. In more specific embodiments, the cyclic phosphazene is fully or partially halogenated. In even more specific embodiments, the cyclic phosphazene is fully or partially fluorinated. In still other embodiments, additionally or alternately, the cyclic phosphazene has one or more substituents selected from linear or cyclic alkyl groups, alkoxy groups, cycloalkoxy groups, and aryloxy groups. In more specific embodiments, the substituents are unhaloghenated, fully halogenated or partially halogenated. In other more specific embodiments, the cyclic phosphazene is fully substituted with halogens and substituents such as linear or cyclic alkyl groups, alkoxy groups, cycloalkoxy groups, and aryloxy groups.

### Cathodes

The cathode active material may be any active material compatible with the anode active material, or any combination of such active materials.

The cathode active material may be in the form of particles, which may be nanoparticles, microparticles, or agglomerates. Particle size includes any coating on cathode active materials. Where multiple cathode active material are present, cathode active materials may have about the same particle size or different particle sizes and similarly may be agglomerated or non-agglomerated, or one particle type may be agglomerated while the other is not.

In some embodiments the cathode active material may be a lithium compound, such as a lithium metal oxide (LMO) or a lithium metal phosphate (LMP).

The cathode active material may generally be present in a crystalline, and not amorphous, form. In particular, the lithium metal oxides may be those that exhibit a layered crystal structure, similar to that of lithium cobalt oxide, more particularly a rhombohedral lattice, hexagonal class crystal structure, such as that of space group R-3m. The lithium metal phosphates may be those that exhibit an orthorhombic crystal structure of space group Pnma, sometimes referred to as an olivine structure. Some cathode active materials may have spinel structure.

In some embodiments, the cathode may contain one or a mixture of cathode active materials. For example, the cathode may include a lithium metal oxide, such a lithium cobalt oxide (LiCoO₂), lithium nickel aluminum oxide (LiNi/Al/O₂), lithium nickel manganese cobalt oxide (LiNi/Mn/CoO₂, also referred to as “NMC”), lithium nickel cobalt aluminum oxide (LiNi/Co/AlO₂, also referred to as “NCA”), lithium nickel manganese cobalt aluminum oxide (LiNi/Mn/Co/AlO₂, also referred to as “NMCA”), or lithium metal phosphate, such as lithium iron phosphate (also referred to as “LFP”), lithium manganese iron phosphate (also referred to as “LMFP”), lithium manganese nickel iron phosphate (also referred to as “LMNFP”), lithium iron cobalt phosphate (“LFCP”), or lithium iron manganese cobalt phosphate (“LFMCP”).

In some embodiments, the cathode, when in an uncycled state, also contains an unlithiated metal oxide, such as an unlithiated metal phosphate in addition to the lithiated materials. In some embodiments, the unlithiated metal oxide has the same chemical composition as the lithiated metal oxide, but without lithium (e.g. LiFePO₄ and FePO₄). In other embodiments, the unlithiated metal oxide has a different chemical composition than the lithiated metal oxide (e.g. LiFePO₄ and MnFePO₄ or LiMn_{0.2}Fe_{0.8}PO₄ and Mn_{0.15}Fe_{0.85}PO₄).

In more specific embodiments, Li may be present in the cathode active materials an amount between about 1 wt % and about 99 wt %, about 1 wt % and about 95 wt %, about 1 wt % and about 90 wt %, about 1 wt % and about 85 wt %, about 1 wt % and about 80 wt %, about 1 wt % and about 50 wt %, about 10 wt % and about 99 wt %, about 10 wt % and about 95 wt %, about 10 wt % and about 90 wt %, about 10 wt % and about 85 wt %, about 10 wt % and about 80 wt %, about 10 wt % and about 50 wt %, about 25 wt % and about 99 wt %, about 25 wt % and about 95 wt %, about 25 wt % and about 90 wt %, about 25 wt % and about 85 wt %, about 25 wt % and about 80 wt %, about 25 wt % and about 50 wt %, about 50 wt % and about 99 wt %, about 50 wt % and about 95 wt %, about 50 wt % and about 90 wt %, about 50 wt % and about 85 wt %, about 50 wt % and about 80 wt %, about 1 wt % and about 20 wt %, about 5 wt % and about 20 wt %, about 10 wt % and about 50 wt %, or about 15 wt % and about 20 wt %. In such embodiments, the anode may not contain lithium ion or lithium metal. In some embodiments, Li may be present in these amounts in the cathode or in the entire cell and the anode may include a lithium reservoir.

In other embodiments the cathode may contain at least two distinct cathode active materials or mixtures of cathode active materials in separate cathode layers to form a bipolar cathode.

In specific embodiments, NMC contains Ni in an amount that is at least 50 wt % of the total weight of Ni, Mn, and Co.

Cathode active materials that contain manganese may suffer decreases in performance or failure due to dissolution of manganese through the cell, particularly during use. Non-lithiated metal phosphate in cathode active materials and cathode of the present disclosure may act as a stabilizing and balancing factor that decreases or prevents manganese dissolution during use of a cell.

In some embodiments, one or more, or all of the cathode active materials may not contain cobalt. In contrast to toxic cobalt, iron, manganese, and nickel are generally non-toxic and, even if released by damage to a battery, are very unlikely to be taken up by the body in harmful amounts. In addition, these cathode active materials may help prevent thermal runaway and resulting battery or cell damage and fires. However, embodiments in which one or more, or all of the cathode active materials do contain cobalt are also suitable for use in a cathode as disclosed herein.

In some embodiments, the NMC has the general chemical formula LiNi_{1-x-y}MnₓCo_{y}O₂, wherein 1−x−y, x, and y are each greater than 0, and 1−x−y is such that Ni is present in an amount of at least 50 wt % of the total weight of Ni, Mn, and Co, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y is such that Ni is present in an amount of at least 80 wt % of the total weight of Ni, Mn, and Co, such as between 80wt % and about 99 wt %, between 80 wt % and about 95 wt %, between 80 wt % and about 90 wt %, or between 80 wt % and about 85 wt %.

In some embodiments in which the NMC has the general chemical formula LiNi_{1-x-y}MnₓCo_{y}O₂, wherein x is such that Mn is present in an amount of up to 30 wt % of the total weight of the NMC. In more specific embodiments, Mn may be present in an amount of between about 1 wt % and 30wt %, about 5 wt % % and 30 wt %, about 10 wt % and 30 wt % %, or about 20 wt % and 30 wt %.

In a more specific embodiment, the NMC has the chemical formula LiNi_{0.8}CO_{0.1}Mn_{0.1}O₂.

In some embodiments, the NCA has the general chemical formula LiNi_{1-x-y}CoₓAl_{y}O₂, wherein 1−x−y, x, and y are each greater than 0. In specific embodiments, 0<x≤0.2, more specifically 0.01≤x≤0.2, 0.1≤x≤0.2 and 0<y≤0.2 more specifically 0.01≤y≤0.2, 0.1≤y≤0.2. In more specific embodiments, 0.6≤(1−x−y)≤0.99, more specifically, 0.6≤(1−x−y)≤0.9, 0.6≤(1−x−y)≤0.8, 0.6≤(1−x−y)≤0.7.

In some embodiments, the NCA has the general chemical formula LiNi_{1-x-y}CoₓAl_{y}O₂, and 1−x−y is such that Ni is present in an amount of at least 50 wt % of the total weight of Ni, Co, and Al, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y is such that Ni is present in an amount of at least 80 wt % of the total weight of Ni, Co, and Al, such as between 80 wt % and about 99 wt %, between 80 wt % and about 95 wt %, between 80 wt % and about 90 wt %, or between 80 wt % and about 85 wt %.

In some embodiments, the NMCA has the general chemical formula LiNi_{1-x-y-z}MnₓCo_{y}Al_{z}O₂, wherein 1−x−y−z, x, y, and z are each greater than 0. In specific embodiments, 0<x≤0.2, more specifically 0.01≤x≤0.2, 0.1≤x≤0.2, 0<y≤0.2 more specifically 0.01≤y≤0.2, 0.1≤y≤0.2, and 0<z≤0.2, more specifically 0.01≤z≤0.2, 0.1≤z≤0.2. In more specific embodiments, 0.4≤ (1−x−y−z)≤0.99, more specifically, 0.4≤(1−x−y)≤0.9, 0.4≤(1−x−y)≤0.8, 0.4≤(1−x−y)≤0.7.

In some embodiments, the NMCA has the general chemical formula LiNi_{1-x-y-z}MnₓCo_{y}Al_{z}O₂, wherein 1−x−y−z is such that Ni is present in an amount of at least 50 wt % of the total weight of Ni, Mn, Co, and Al, such as between 50 wt % and about 99 wt %, between 50 wt % and about 95 wt %, between 50 wt % and about 90 wt %, between 50 wt % and about 85 wt %, between about 50 wt % and about 80 wt %, between 50 wt % and about 75 wt %, between 50 wt % and about 70 wt %, between 50 wt % and about 65 wt %, between 50 wt % and about 60 wt %, or between 50 wt % and about 55 wt %. In some embodiments, 1−x−y−z is such that Ni is present in an amount of at least 80 wt % of the total weight of Ni, Mn, Co, and Al, such as between 80 wt % and about 99 wt %, between 80 wt % and about 95 wt %, between 80 wt % and about 90 wt %, or between 80 wt % and about 85 wt %.

In some embodiments, the LFP has the general chemical formula LiFePO₄.

Lithium metal phosphate cathode active materials 50a may include LMFP. In some embodiments, these materials have the general chemical formula LiMnₓFe₁₋ₓPO₄, wherein 0.01≤x≤0.95.

In more specific embodiments, 0.01≤x≤0.5, 0.01≤x≤0.4, 0.01≤x≤0.3, 0.01≤x≤0.25, 0.01≤x≤0.2, 0.01≤x≤0.15, 0.01≤x≤0.10, 0.01≤x≤0.05, 0.05≤x≤0.95, 0.05≤x≤0.5, 0.05≤x≤0.4, 0.05≤x≤0.3, 0.05≤x≤0.25, 0.05≤x≤0.2, 0.05≤x≤0.15, 0.05≤x≤0.1, 0.1≤x≤0.95, 0.1≤x≤0.5, 0.1≤x≤0.4, 0.1≤x≤0.3, 0.1≤x≤0.25, 0.1≤x≤0.2, 0.1≤x≤0.15, 0.15≤x≤0.95, 0.15≤x≤0.5, 0.15≤x≤0.4, 0.15≤x≤0.3, 0.15≤x≤0.25, 0.15≤x≤0.2, 0.2≤x≤0.95, 0.2≤x≤0.5, 0.2≤x≤0.4, 0.2≤x≤0.3, or 0.2≤x≤0.25. In a more specific embodiment, the materials have the chemical formula LiMn_{0.2}Fe_{0.8}PO₄.

In other more specific embodiments, 0.5≤x≤0.95, 0.5≤x≤0.8, 0.5≤x≤0.7, 0.5≤x≤0.6, 0.6≤x≤0.95, 0.6≤x≤0.8, 0.6≤x≤0.7, 0.7≤x≤0.95, 0.7≤x≤0.8, or 0.8≤x≤0.95. In a more specific embodiment, the materials have the chemical formula LiMn_{0.5}Fe_{0.5}PO₄, and LiMn_{0.8}Fe_{0.2}PO₄.

Lithium metal phosphate cathode active materials 50a may include LMNFP. In some embodiments, these materials have the general chemical formula LiMnₓNi_{y}Fe_{1-(x+y)}PO₄, in which 0<x<1, 0<y<1 and x+y<1. In some specific embodiments:
a) 0<x≤0.05, more particularly 0.005≤x≤0.05, 0.005≤x≤0.04, 0.005≤x≤0.03, 0.005≤x≤0.02, 0.01≤x≤0.05, 0.01≤x≤0.04, 0.01≤x≤0.03, 0.01≤x≤0.02, 0.02≤x≤0.05, 0.02≤x≤0.04, 0.02≤x≤0.03, 0.03≤x≤0.05, 03, 0.03≤x≤0.04, or 0.04≤x≤0.05;
b) 0<y≤0.3, more particularly 0.005≤y≤0.3, 0.005≤y≤0.25, 0.005≤y≤0.2, 0.005≤y≤0.16, 0.005≤y≤0.15, 0.005≤y≤0.1, 0.005≤y≤0.05, 0.005≤y≤0.01, 0.01≤y≤0.3, 0.01≤y≤0.25, 0.01≤y≤0.2, 0.01≤y≤0.16, 0.01≤y≤0.15, 0.01≤y≤0.1, 0.01≤y≤0.05, 0.05≤y≤0.3, 0.05≤y≤0.25, 0.05≤y≤0.2, 0.05≤y≤0.16, 0.05≤y≤0.15, 0.05≤y≤0.1, 0.1≤y≤0.3, 0.1≤y≤0.25, 0.1≤y≤0.2, 0.1≤y≤0.16, 0.1≤y≤0.15, 0.15≤y≤0.3, 0.15≤y≤0.25, 0.15≤y≤0.2, 0.15≤y≤0.16, 0.16≤y≤0.3, 0.16≤y≤0.25, 0.16≤y≤0.2, 0.2≤y≤0.3, 0.2≤y≤0.25, or 0.25≤y≤0.3; or
c) 0<x+y≤0.3, more particularly 0.005≤x+y≤0.3, 0.005≤x+y≤0.25, 0.005≤x+y≤0.2, 0.005≤x+y≤0.15, 0.005≤x+y≤0.1, 0.005≤x+y≤0.05, 0.005≤x+y≤0.01, 0.01≤x+y≤0.3, 0.01≤x+y≤0.25, 0.01≤x+y≤0.2, 0.01≤x+y≤0.15, 0.01≤x+y≤0.1, 0.01≤x+y≤0.05, 0.05≤x+y≤0.3, 0.05≤x+y≤0.25, 0.05≤x+y≤0.2, 0.05≤x+y≤0.15, 0.05≤x+y≤0.1, 0.1<x+y≤0.3, 0.1≤x+y≤0.25, 0.1≤x+y≤0.2, 0.1≤x+y≤0.15, 0.15≤x+y≤0.3, 0.15≤x+y≤0.25, 0.15≤x+y≤0.2, 0.2≤x+y≤0.3, 0.2≤x+y≤0.25, or 0.25≤x+y≤0.3.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2,and 2:1 and 1:1.

In a more specific embodiment, the materials have the chemical formula LiMn_{0.04}Ni_{0.16}Fe_{0.8}PO₄.

In some embodiments, LFCP has the general chemical formula LiFe₁₋ₓCoₓPO₄, in which 0<x<1. In some specific embodiments, x≥0.05, x≥0.1, x≥0.2, x≥0.3, x≥0.4, x≥0.5, x≥0.6, x≥0.7, x≥0.8, x≥0.9, or x≥0.95.

In some embodiments, LFMCP has the general chemical formula LiFe_{1-(x+y)}MnₓCo_{y}PO₄, in which 0<x<1, 0<y<1 and x+y<1. In some specific embodiments, a) 0<x≤0.5, more particularly 0.05≤x≤0.50, 0.05≤x≤0.25, 0.05≤x≤0.2, 0.05≤x≤0.15, 0.05≤x≤0.1, 0.1≤x≤0.5, 0.1≤x≤0.25, 0.1≤x≤0.2, or 0.1≤x≤0.15; b) 0<y≤0.95, more particularly 0.05≤y≤0.95, 0.05≤y≤0.9, 0.05≤y≤0.75, 0.05≤y≤0.5, 0.05≤y≤0.25, 0.05≤y≤0.1, 0.1≤y≤0.95, 0.1≤y≤0.9, 0.1≤y≤0.75, 0.1≤y≤0.5, or 0.1≤y≤0.25; or c) 0<x+y≤0.95, more particularly 0.05≤x+y≤0.95, 0.05≤x+y≤0.75, 0.05≤x+y≤0.5, 0.05≤x+y≤0.25, 0.05≤x+y≤0.1, 0.1≤x+y≤0.95, 0.1≤x+y≤0.9, 0.1≤x+y≤0.75, 0.1≤x+y≤0.5, or 0.1≤x+y≤0.25.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2,more particularly between 5:1 and 1:1, 4:1 and 1:2, 4:1 and 1:1, 3:1 and 1:2, 3:1 and 1:1, 2:1 and 1:2, and 2:1 and 1:1.

In some embodiments, lithium cobalt oxide, lithium nickel aluminum oxide, NMC, NCA, NMCA, LFP, LMFP, LMNFP, LFCP, or LFMCP may include additional elements included in their crystal structures. These additional elements may affect electrical conductivity and/or lithium ion intercalation of the cathode active material. Additional elements may have or be capable of existing in a charge state equal to that of the element replaced in the crystal structure. For example, iron may be replaced with another element that may exist in a 2+ or 3+ charge state.

The additional element may be a transition metal also able to move from one charge to another during an electrochemical reaction, or if may be a fixed valence material, such as a fixed-valence 2+ metal in place of iron. Phosphorus may also be replaced, where present with sulfur or silicon. The amount of transition metal replaced by another metal may be 10%, 5%, 2%, 1%, 0.5%, or 0.1% or less, or in a range of 0.1% to 10%, 0.1% to 5%, 0.1% to 2%, 0.1% to 1%, 0.1% to 0.5%, 0.5% to 5%, 0.5% to 2%, 0.5% to 1%, 1% to 5%, 1% to 2%, or 2% to 5%.

In some embodiments, the cathode active materials of the present disclosure are particles of lithium metal phosphate or metal phosphate coated with a conductive carbon layer which is bonded to the lithium metal phosphate or metal phosphate. It is well understood that a conductive carbon layer is needed for LFP, LMFP, LMNFP, LFCP, LFMCP, FP, MFP, MNFP, FCP, or FMCP to be electrochemically active in a cathode, and the conductive carbon layer may be any type suitable for this purpose. In addition, the conductive carbon layer may be formed using any process that results in a suitable conductive carbon layer, including both processes performed on existing lithium metal phosphates or metal phosphates and processes in which the lithium metal phosphate or metal phosphate and conductive carbon layer are both formed during the same process, as well as processes that include reducing, oxidizing, or inert atmospheres. In some embodiments, the conductive carbon layer is present in a wt % of between about 0.5 wt % and about 3 wt % of the total weight of lithium metal phosphate or metal phosphate and carbon layer. In more specific embodiments, the conductive carbon layer may be present in a wt % between about 0.5 wt % and about 2 wt %, between about 0.5 wt % and about 1 wt %, between about 1 wt % and about 3 wt %, between about 1 wt % and about 2 wt %, or between about 2 wt % and about 3 wt %.

Except in embodiments where solely the lithium metal phosphate or metal phosphate is being described (e.g. the chemical formula of LMFP), the “cathode active material” includes any carbon coating. For example, when the wt % of LMFP in a cathode material combination or cathode layer is discussed, the relevant LMFP weight includes any conductive carbon coating on the underlying lithium manganese iron phosphate.

The lithium compound may include a halide, such as F, or the lithium compound material may be doped with an inorganic halide composition, such as an inorganic fluoride composition, such as a metal flouride.

The cathode active material 50 may be coated, for example with an inorganic halide composition, such as an inorganic fluoride composition, such as a metal fluoride, or a conductivity enhancer, such as carbon.

In more specific embodiments, the metal fluorides may be LiF, ZnF₂, AlF₃, and any combinations thereof. AlF₃ may be particularly useful due to its reasonable cost and low negative environmental impact.

The cathode active material may have a voltage of at least 1.45 V vs. lithium metal.

The cathode active material may be coated, for example with an inorganic halide composition, such as an inorganic fluoride composition, or a conductivity enhancer, such as carbon.

The cathode active material may be in a cathode active material-containing layer, which may include at least 90 wt % cathode active material 50 which, for purposes of this measurement, includes any coating or dopant. More specifically, the cathode active material-containing layer may include between about 90 wt % and about 99 wt %, about 90 wt % and about 98 wt %, about 90 wt % and about 97 wt %, about 90 wt % and about 96 wt %, or about 90 wt % and about 95 wt % cathode active material 50.

The cathode active-material containing layer may contain additional materials, such as polymer binders and conductivity enhancers and combinations thereof.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the cathode active-material containing layer may include 5 wt % or less conductivity enhancer. More specifically, the cathode active-material containing layer 30 may include between about 1 wt % and about 5wt %, between about 2 wt % and about 5 wt %, about 1 wt % and about 4 wt %, about 2 wt % and about 4 wt %, or about 3 wt % and about 4 wt % conductivity enhancer.

In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber (SBR), styrene-butadiene rubber/carboxyl methyl-cellulose (SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In some embodiments, the cathode active-material containing layer may include 6 wt % or less polymer binder. More specifically, the cathode active-material containing layer may include between about 1 wt % and about 6 wt %, between about 2 wt % and about 6 wt %, about 1 wt % and about 5 wt %, about 2 wt % and about 5 wt %, or about 3 wt % and about 5 wt % polymer binder.

The cathode may contain more than one cathode active-material containing layers, which may differ in the type of amount of cathode active material(s).

The cathode 120 also includes a cathode current collector, which may be any suitable electrically conductive material, such as a metal foil, a metal grid, a metal screen, metal foam, expanded metal (which is a metal grid or metal screen that has a thickness sufficient to allow a substantial amount of cathode active material to collect within it), or at least one graphene layer, typically a plurality of graphene layers. In some embodiments, cathode current collector 40 may include Al, Ni, Ti, C, stainless steel, or any combinations thereof. In a specific embodiment, the cathode current collector 40 is aluminum, more specifically aluminum foil. In some embodiments, if the current collector includes or is a metal, it may further include a conductive and corrosion-resistant coating, such as TiN.

In some embodiments, not depicted, cathode active material-containing layers may be formed on both sides of the cathode current collector.

### Anodes

The anode 130 includes an anode active material, which may be in an anode active material-containing layer. In some embodiments, the anode active material-containing layer may be formed entirely of anode active material.

In anodes 130 where lithium ions plate out as lithium metal (or a different working ion plates out as its metal), the anode active material-containing layer may include the anode active material and plated out lithium metal (or other working ion metal) on the anode active material, in varying amounts of lithium metal (or other working ion metal) depending on the charge/discharge state of the cell or battery. In other embodiments, the lithium metal (or other working ion metal) may be alloyed with or intercalated in the anode active material.

In some embodiments, the anode may include more than one active material and may even include a cathode active material, such as lithium iron phosphate.

In some embodiments, the anode active material may include a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof.

If the anode contains two anode active materials, the first anode active material and the second anode active material may be different types of material (e.g. they may not both be synthetic graphites). In some embodiments, the first anode active material and the second anode active material may be the same type of material, but have different chemical compositions or electric properties (e.g. they may both be graphenes, but with different functional groups or difference electric conductivities

In more specific embodiments containing a metal alloy, the metal alloy may be combined with an intercalation carbon or a conductive carbon.

In some embodiments, the anode active material may be elemental silicon (also referred to herein as simply “silicon”), a silicon compound, particularly SiOₓ in which x<2, or in which x≤2, or any combinations thereof. In specific embodiments, the silicon compound may be SiOₓ in which x<2. In some specific embodiments, the silicon may be present in particles, particularly nanoparticles. In some embodiments, the following reaction may occur with silicon in the anode 130: (SiO+Li→Li₂O+Li×Si Li₂O) (ICL).

In some embodiments, the anode active material may be a combination of a hard carbon and amorphous silicon or silicon nanotubes.

In some embodiments, the anode active material-containing layer may include a lithium reservoir (or a counterpart working ion metal reservoir), which contains lithium metal, lithium alloy, or lithium salt (or analogous working ion materials) not intercalated in or alloyed with the anode active material in an uncyled cell or battery containing the slot electrode stack 100. In some embodiments, lithium reservoir materials may be coated on the anode active material.

In some embodiments, where the anode active material-containing layer is sufficiently conductive, the anode 130 may lack a separate anode current collector.

The anode 130 may contain more than one cathode active-material containing layers, which may differ in the type of amount of cathode active material(s).

In some embodiments, anode active 130 may lack any lithium metal or lithium ion prior to assembly into cell 10 or prior to the first charge/discharge cycle e.g. when the anode is uncycled. The absence of lithium metal helps preserve excess lithium ion intercalation capacity in the cathode 120 for use if overcharge occurs. In other cases, the anode may include Li+ or Li in the form of a reservoir to supply additional Li+ if the solid electrolyte interface (SEI) consumes too much Li+ during formation.

Suitable additional materials that may be present in anode 130 include polymer binders, conductivity enhancers and combinations thereof.

Suitable conductivity enhancers include carbon fibers, such as vapor grown carbon fibers (VGCF), carbon nanorods, graphite, or carbon blacks, such as acetylene black, Denka black, Keitjen black, hard carbon, silver/gold nano-wires or particles, or any combinations thereof.

In some embodiments, the anode active material-containing layer may include 5 wt % or less conductivity enhancer. More specifically, the anode active material-containing layer may include between about 1 wt % and about 5wt %, between about 2 wt % and about 5 wt %, about 1 wt % and about 4 wt %, about 2 wt % and about 4 wt %, or about 3 wt % and about 4 wt % conductivity enhancer.

In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber (SBR), styrene-butadiene rubber/carboxyl methyl-cellulose

(SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In some embodiments, the anode active material-containing layer 120 may include 5 wt % or less polymer binder. More specifically, the anode active material-containing layer 120 may include between about 1 wt % and about 5wt %, between about 2 wt % and about 5 wt %, about 1 wt % and about 4 wt %, about 2 wt % and about 4 wt %, or about 3 wt % and about 4 wt % polymer binder.

The anode 130 may include an anode current collector, which may be any suitable electrically conductive material, such as a metal foil, a metal grid, a metal screen, metal foam, or expanded metal (which is a metal grid or metal screen that has a thickness sufficient to allow a substantial amount of cathode active material to collect within it) or at least one graphene layer, typically a plurality of graphene layers. In some embodiments, anode current collector may include Ni, Ti, C, Cu, stainless steel, or any combinations thereof. In a specific embodiment, the anode current collector is copper, more specifically copper foil. In some embodiments, if the current collector includes or is a metal, it may further include a conductive and corrosion-resistant coating, such as TiN.

In some embodiments, not depicted, anode active material-containing layers may be formed on both sides of the anode current collector.

In some embodiments, the anode may include graphite, silicon, or both in the form or particles or separate layers.

In some embodiments, the anode is a high capacity lithium ion anodes that includes a lithium reservoir, such as a graphite-silicon composition anode active material along with a lithium reservoir. The lithium reservoir, in various embodiments, may be lithium metal present in the anode, but not intercalated in the graphite-silicon composition, such as lithium particles or foil, or a lithium salt present in the anode as either free lithium salt or coated on the graphite-silicon composition, or any combinations thereof. It will be understood by one of skill in the art that these initial anode structures exist prior to cell or battery assembly and/or prior to cycling, e.g. in an uncycled cell or battery assembly.

The lithium salt may, in particular embodiments, be lithium bis(trifluoromethanesulfonyl)imide (LIFSI), lithium bis(trifluoromethanesulfonyl)imide (LiTFSI), lithium tetrafluoroborate (LiBF₄), lithium 4,5-dicyano-2-(trifluoromethyl) imidazole (LiTDI), lithium hexafluorophosphate (LiPF₆), lithium iodide (LiI), or any mixtures or combinations thereof, particularly 1-Butyl-3-methylimidazolium bis(trifluoromethanesulfonyl)imide combined with LiTFSI. The lithium salt may further include compounds to enhance electrode stability by impeding the reaction of lithium

In some embodiments, the anode may include pre-lithiated silicon.

The various embodiments described above can be combined to provide further embodiments. Aspects of the embodiments can be modified in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A slot electrode stack comprising:
an electrically insulative separator folded into an accordion shape and having a plurality of first slots on one side and a plurality of second slots on an opposite side;
a plurality of uncycled cathodes located in the plurality of first slots, wherein the plurality of uncycled cathodes comprise a cathode active material comprising a lithium manganese iron phosphate (LMFP) cathode active material, a lithium manganese nickel iron phosphate (LMNFP) cathode active material, a lithium iron phosphate (LFP) cathode active material, a lithium iron cobalt phosphate (LFCP) cathode active material, a lithium iron manganese cobalt phosphate (LFMCP) cathode active material, or any combinations thereof.
wherein:
the LMFP cathode active material has the general chemical formula LiMnₓFe₁₋₋ₓPO₄, wherein 0.01≤x≤0.95;
the LMNFP cathode active material has the general chemical formula LiMnₓNi_{y}Fe_{1-(x+y)}PO₄, wherein 0<x<1, 0<y<1 and x+y<1 and wherein the ratio of x:y is in a range between 5:1 and 1:5;
the LFCP cathode active material has the general chemical formula LiFe₁₋ₓCoₓPO₄, in which 0<x<1;
the LFMCP cathode active material has the general chemical formula LiFe_{1-(x+y)}MnₓCo_{y}PO₄, wherein 0<x<1, 0<y<1 and x+y<1 and wherein the ratio of x:y is in a range between 5:1 and 1:5; and
wherein at least one of the LMFP, LMNFP, LFCP, LFMCP, or LFP is coated with conductive carbon; and
a plurality of anodes located in the plurality of second slots.

2. The slot electrode stack of claim 1, further comprising a plurality of stopping points, each located at an end of a first slot or a second slot, wherein the plurality of cathodes and plurality of anodes do not reach the plurality of stopping points.

3. (canceled)

4. The slot electrode stack of claim 1, wherein the plurality of cathodes each comprise a cathode active material in a cathode active material layer on both sides of a cathode current collector, and wherein the plurality of anodes each comprise an anode active material in an anode active material layer on both sides of an anode current collector.

5-9. (canceled)

10. The slot electrode stack of claim 1, wherein the anode active material comprises a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, hard carbon, or hard carbon and amorphous silicon or silicon nanotubes, or any combinations thereof.

11. The slot electrode stack of claim 1, wherein the anode further comprises a lithium ion reservoir and/or further comprises a cathode active material.

12. (canceled)

13. The slot electrode stack of claim 1, wherein the separator comprises polyethylene, polypropylene, a ceramic-polymer composite, polyvinylidene fluoride (PVDF), PVDF-poly(ethylene oxide) (PEO), or any combinations thereof.

14. The slot electrode stack of claim 1, wherein the plurality of cathodes and plurality of anodes each have at least two tabs that allow current to flow to and from the cathodes and anodes.

15. A slot electrode cell comprising:
a slot electrode stack of claim 1;
an electrolyte; and
a casing.

16. The slot electrode cell of claim 15, wherein the slot electrode cell is substantially flat and has a length, width, and height, at least one of which is at least 15 cm.

17-23. (canceled)

24. The slot electrode stack of claim 1, wherein the cathode active material comprises:
i) a lithium manganese iron phosphate (LMFP) cathode active material, a lithium manganese nickel iron phosphate (LMNFP) cathode active material, a lithium iron phosphate (LFP) cathode active material, a lithium iron cobalt phosphate (LFCP) cathode active material, a lithium iron manganese cobalt phosphate (LFMCP) cathode active material, or any combinations thereof; and
ii) a manganese iron phosphate (MFP) cathode active material, a manganese nickel iron phosphate (MNFP) cathode active material, an iron phosphate (FP) cathode active material, an iron cobalt phosphate (FCP) cathode active material, an iron manganese cobalt phosphate (FMCP) cathode active material, or any combinations thereof,
wherein:
the MFP cathode active material has the general chemical formula MnₓFe₁₋ₓPO₄, wherein 0.01≤x≤0.95;
the MNFP cathode active material has the general chemical formula MnₓNi_{y}Fe_{1-(x+y)}PO₄, wherein 0<x<1, 0<y<1 and x+y<1, and wherein the ratio of x:y is in a range between 5:1 and 1:5.;
the FCP cathode active material has the general chemical formula Fe₁₋ₓCoₓPO₄, in which 0<x<1; and
the FMCP cathode active material has the general chemical formula Fe_{1-(x+y)}MnₓCo_{y}PO₄, wherein 0<x<1, 0<y<1 and x+y<1 and wherein the ratio of x:y is in a range between 5:1 and 1:5; and
wherein at least one of the LMFP, LMNFP, LFCP, LFMCP, LFP, MFP, MNFP, FCP, FMCP, or LP is coated with conductive carbon.

25. A slot electrode stack comprising:
an electrically insulative separator folded into an accordion shape and having a plurality of first slots on one side and a plurality of second slots on an opposite side;
a plurality of bipolar cathodes located in the plurality of first slots, wherein the plurality of bipolar cathodes comprise two different cathode active materials located in two distinct cathode layers on a single current collector,
wherein:
i) the two different cathode layers are disposed adjacent to one another, and the current collector is disposed adjacent to one cathode layer only;
ii) the current collector is disposed adjacent to and between the two different cathode layers;
iii) the two different cathode layers are both disposed adjacent to the current collector in different regions on a surface of the current collector; or
iv) the cathode comprises two layers each of the distinct cathode layers in which, on one side of the current collector, the two different cathode layers are disposed adjacent to one another and the current collector is disposed adjacent to a first type of cathode layer only and, on an opposite side of the current collector, two different cathode layers are disposed adjacent to cone another and the current collector is disposed adjacent to the first type of cathode layer only; and
wherein the two different cathode active materials are selected from: lithium nickel manganese cobalt oxide (NMC) in which nickel (Ni) is present in at least 50 wt % of the total weight of Ni, manganese (Mn), and cobalt (Co); lithium nickel cobalt aluminum oxide (NCA); lithium nickel manganese cobalt aluminum oxide (NMCA), lithium iron phosphate (LFP), lithium manganese iron phosphate (LMFP), lithium manganese nickel iron phosphate (LMNFP), lithium iron cobalt phosphate (LFCP), lithium iron manganese cobalt phosphate (LFMCP), and any combinations thereof; and
a plurality of anodes located in the plurality of second slots.

26. The slot electrode stack of claim 25, wherein the NMC has the general chemical formula LiNi_{1-x-y}MnₓCo_{y}O₂, wherein 1−x−y, x, and y are each greater than 0, and 1−x−y is such that Ni is present in an amount of at least 50 wt % of the total weight of Ni, Mn, and Co; or wherein x is such that Mn is present in an amount of up to 30 wt % of the total weight of the NMC;
the NCA has the general chemical formula LiNi_{1-x-y}CoₓAl_{y}O₂, wherein 0<x≤0.2 and 0<y≤0.2, or wherein 1−x−y is such that Ni is present in an amount of at least 50 wt % of the total weight of Ni, Co, and aluminum (Al);
the NMCA has the general chemical formula LiNi_{1-x-y-z}MnₓCo_{y}Al_{z}O₂, wherein 0<x≤0.2, 0<y≤0.2, and 0<z<0.2, or wherein 1−x−y−z is such that Ni is present in an amount of at least 50 wt % of the total weight of Ni, Mn, Co, and Al;
the LFP has the general chemical formula LiFePO₄;
the LMFP has the general chemical formula LiFe₁₋ₓMnₓPO₄, wherein 0<x<1;
the LMNFP has the general chemical formula LiFe_{1-(x+y)}MnₓNi_{y}PO₄, wherein 0<x<1, 0<y<1 and x+y<1;
the LFCP has the general chemical formula LiFe₁₋ₓCoₓPO₄, in which 0<x<1; and
the LFCMP has the general chemical formula LiFe_{1-(x+y)}MnₓCo_{y}PO₄, in which 0<x<1, 0<y<1 and x+y<1.

27. The slot electrode stack of claim 25, further comprising a plurality of stopping points, each located at an end of a first slot or a second slot, wherein the plurality of cathodes and plurality of anodes do not reach the plurality of stopping points.

28. The slot electrode stack of claim 25, wherein the plurality of cathodes each comprise a cathode active material in a cathode active material layer on both sides of a cathode current collector, and wherein the plurality of anodes each comprise an anode active material in an anode active material layer on both sides of an anode current collector.

29. The slot electrode stack of claim 25, wherein the anode active material comprises a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, hard carbon, or hard carbon and amorphous silicon or silicon nanotubes, or any combinations thereof.

30. The slot electrode stack of claim 25, wherein the anode further comprises a lithium ion reservoir and/or further comprises a cathode active material.

31. The slot electrode stack of claim 25, wherein the separator comprises polyethylene, polypropylene, a ceramic-polymer composite, polyvinylidene fluoride (PVDF), PVDF-poly(ethylene oxide) (PEO), or any combinations thereof.

32. The slot electrode stack of claim 25, wherein the plurality of cathodes and plurality of anodes each have at least two tabs that allow current to flow to and from the cathodes and anodes.

33. A slot electrode cell comprising:
a slot electrode stack of claim 25;
an electrolyte; and
a casing.

34. The slot electrode cell of claim 33, wherein the slot electrode cell is substantially flat and has a length, width, and height, at least one of which is at least 15 cm.
